(19) United States
(12) Patent Application Publication
(10) Pub. No.: US 2010/0220781 A1
(43) Pub. Date: Sep. 2, 2010

(54) MOVING PICTURE DECODING APPARATUS

(75) Inventors: Yohei Ikeuchi, Osaka (JP); Kengo Nishimura, Osaka (JP); Naoki Sakata, Osaka (JP); Syoji Kawamura, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/738,773

(22) PCT Filed: Sep. 4, 2008
(86) PCT No.: PCT/JP2008/002442

§ 371 Date: Apr. 19, 2010

(30) Foreign Application Priority Data
Oct. 31, 2007 (JP) 2007-284562

(51) Int. Cl. H04N 7/26

(52) U.S. Cl. 375/240.02; 375/240.25; 375/240.27; 345/545; 348/725; 375/E07.026

(57) ABSTRACT

A moving picture decoding apparatus capable of performing time-division decoding processing with the least possible idle time by making the best use of a decoder includes: a buffer memory storing moving picture streams of channels; a video decoder which decodes the moving picture streams of channels read out from the buffer memory; a frame buffer which stores moving picture data of the moving picture streams decoded by the video decoder; a display control unit which reads out the moving picture data from the frame buffer and outputs a moving picture signal corresponding to the moving picture data; and a decoding control unit which causes the video decoder to decode the moving picture streams in a time division manner by switching the moving picture streams which the decoding control unit supplies from the buffer memory to the video decoder.

### TECHNICAL FIELD

The present invention relates to moving picture decoding apparatuses, and in particular to a moving picture decoding apparatus using a moving picture decoding technique.

### BACKGROUND ART

So far there have been numerous moving picture decoding apparatuses proposed which use moving picture decoding techniques (including Patent Reference 1, for example).

FIG. 1 is a block diagram showing a configuration of a conventional moving picture decoding apparatus 900 disclosed in Patent Reference 1. In the conventional moving picture decoding apparatus 900, inputted bit streams are stored in a buffer 903, and header information of respective layers above a picture layer and slice information linked to the header information are also stored in the buffer 903. The conventional moving picture decoding apparatus 900 decodes bit streams in a time division manner with a timing of a synchronization signal of each channel. At this time, the header information stored in the buffer 903 is analyzed.

The conventional moving picture apparatus 900 includes: a unit in which the inputted bit streams are stored; a unit which extracts information from a header of layers of hierarchically higher levels than the picture layer in each of the inputted bit streams, to generate header information for each of the bit streams, and stores the header information for each of the bit streams; a unit which extracts information from a header of a slice layer of each of the inputted bit streams, to generate slice information including a position at which the slice starts in the stored bit stream and a position at which the slice starts in a picture, and stores the slice information for each of the bit streams; a unit which adds link information indicative of a position of the slice information included in a picture, to picture information of the header information for each of the bit streams; and a unit which receives a synchronization signal, based on which a timing of decoding each of the bit streams is set, then reading out the header information of the bit stream corresponding to the synchronization signal, analyzing the header information of the bit stream corresponding to the synchronization signal, and decoding in time division manner the analyzed header information of the bit stream corresponding to the synchronization signal, together with other bit streams, by using the header information analyzed per predetermined unit.

### Patent Reference 1: Japanese Unexamined Patent Application Publication JP-A 2003-009147

### DISCLOSURE OF INVENTION

### Problems that Invention is to Solve

However, the method of starting decoding processing with a timing of VSYNC, which is a synchronization signal, of each channel, as employed by the conventional moving picture decoding apparatus, has the following problems.

1) Depending on the timing of the VSYNC of each channel, a decoding circuit becomes idle for a certain period of time which is referred to as an idle time. The decoding circuit for performing the decoding processing thus cannot be fully utilized.

2) While one of the channels is being used in a special playback mode, throughput for the other of the channels falls short. Heavy decoding processing loads in one channel thus make the operation of the decoding processing in the other channels unreliable.

The above problems will be discussed with reference to the drawings. Herein, the number of channels, into which the bit streams are time-divided, is assumed to be two.

FIG. 2 is a view showing how the conventional moving picture decoding apparatus performs its time-division decoding processing.

FIG. 3 is a view showing how the conventional moving picture decoding apparatus performs its time-division decoding processing.

The bit streams of two channels are time-divided by one decoding unit and then decoded. To be specific, the bit streams of the two channels (hereinafter referred to as Ch0 and Ch1) are decoded by two logical decoders (hereinafter referred to as Dec0 and Dec1). A synchronization signal Vsync0 corresponding to the bit stream of Ch0 and a synchronization signal Vsync1 corresponding to the bit stream of Ch1 are inputted alternately. Furthermore, the timing of Vsync0 input, i.e., Tvsync0, is independent of the timing of Vsync1 input, i.e., Tvsync1.

As shown in FIG. 2, the decoding processing in Dec0 for the bit stream corresponding to Vsync0 ends between Tvsync0 and Tvsync1. At Tvsync0, Vsync0 is inputted, and at Tvsync1, Vsync1 is inputted. Furthermore, in the case where the decoding processing in Dec0 ends between Tvsync0 and Tvsync1, there is an idle time in which no decoding processing is performed, until the next input at Tvsync1 at which the decoding processing for the bit stream corresponding to Vsync1 starts in Dec1.

FIG. 3 shows another case of FIG. 2 in the special playback mode, for example, in which the bit stream of Ch1 is processed at double speed. As shown in FIG. 3, the decoding process may not be able to end in Dec1 between Tvsync1 and Tvsync0, when Dec1 is performing the decoding processing at double speed, which takes longer to complete with heavy loads of processing. At Tvsync1, Vsync1 is inputted, and at Tvsync1, Vsync0 is inputted. This means that Dec0 cannot start the processing to decode the bit stream corresponding to Ch0. In conclusion, there is a case where, when one channel (Ch1) has heavy decoding processing loads, the other channel (Ch0) is unable to start decoding processing, which means that the operation of the decoding processing in the other channels is unreliable.

The present invention has been devised in view of the above problems and its object is to provide a moving picture decoding apparatus which has one decoder that decodes bit streams of multiple channels through the time-division processing and which is capable of performing decoding processing in the time division manner with the least possible idle time by making the best use of the decoder.

### Means to Solve the Problems

In order to solve the above problems, the moving picture decoding apparatus is characterized by including: a buffer memory in which moving picture streams of channels are stored; a video decoder which decodes the moving picture streams of channels read out from the buffer memory; a frame buffer which stores moving picture data of the moving picture streams of channels, the moving picture streams being decoded by the video decoder; a display control unit configured to read out the moving picture data from the frame buffer and output a moving picture signal corresponding to the moving picture data; and a decoding control unit configured to cause the video decoder to decode the moving picture streams in a time division manner by switching the moving picture streams of channels which the decoding control unit supplies from the buffer memory to the video decoder.

With this structure, the moving picture stream which the video decoder decodes is controlled by the decoding control unit independently of the video decoder so that the video decoder can dedicate itself to perform its decoding processing. Since the moving picture stream which the video decoder decodes is appropriately controlled by the decoding control unit according to circumstances, the video decoder can decode the moving picture stream in the time division manner with the least possible idle time, allowing for the best use of the decoding time that the video decoder performs the decoding processing.

Accordingly, the moving picture decoding apparatus which has one decoder that decodes the data of multiple channels through the time-division processing is capable of making the best use of the decoder and thereby performing the time-division decoding processing with the least possible idle time.

Furthermore, the decoding control unit mat be configured to supply the respective moving picture streams of channels to the video decoder in a cycle, and when the video decoder starts decoding the moving picture stream of a first channel and within one period of the cycle after the start of the decoding, the video decoder completes decoding a picture of the moving picture stream of the first channel, the decoding control unit may be configured to supply the video decoder with a subsequent picture of the moving picture stream of the first channel, the subsequent picture being decoded by the video decoder.

With this structure, the moving picture stream which the video decoder decodes is controlled by the decoding control unit at the predetermined time intervals so that the video decoder can decode the moving picture stream in the time division manner with the minimum decoding time intervals secured. This allows the display control unit to output a plurality of moving picture signals at the same time, with the result that a user can watch multiple moving pictures displayed on a split screen.

Furthermore, the frame buffer may have areas for the respective moving picture streams of channels, and when the area for the moving picture stream of the first channel lacks sufficient free space, the decoding control unit may be configured to supply the video decoder with the moving picture stream of a second channel even before a lapse of the one period of the cycle.

With this structure, as soon as the frame buffer in which the moving picture stream of a certain channel is stored runs out of space, the moving picture stream is switched to a moving picture stream of another channel. The data of the moving picture stream which would not be able to be stored in the frame buffer after decoded by the video decoder thus will not be decoded, so that the length of time for substantial decoding processing of the video decoder can be maximized.

Furthermore, when the video decoder starts decoding the moving picture stream of the first channel and within the one period of the cycle after the start of the decoding, the video decoder completes decoding the picture of the moving picture stream of the first channel, the decoding control unit may be configured to determine, according to a content of the moving picture stream of the first channel, whether to supply the subsequent picture of the moving picture stream of the first channel or to supply the moving picture data of the second channel.

With this structure, the moving picture which results in the moving picture signals to be outputted at the predetermined time intervals by the display control unit is stored in the frame buffer after decoded in the time division manner by the video decoder within the predetermined decoding time whose minimum length is secured.

Furthermore, the moving picture decoding apparatus may further include a save memory which holds data of one of the moving picture streams of channels not completely decoded by the video decoder, wherein when the video decoder is decoding the moving picture stream of a first channel upon switching of the moving picture streams of channels which the video decoder decodes, from the moving picture stream of the first channel to the moving picture stream of a second channel, the decoding control unit may be configured to instruct the save memory to hold data of the moving picture stream of the first channel not completely decoded by the video decoder.

Furthermore, when the save memory holds the data of the moving picture stream of the second channel not completely decoded by the video decoder upon switching of the moving picture streams of channels which the video decoder decodes, from the moving picture stream of the first channel to the moving picture stream of the second channel, the decoding control unit may be configured to instruct the save memory to read out the data of the moving picture stream of the second channel to the video decoder.

With this structure, when the moving picture stream which the video decoder decodes is controlled at the predetermined time intervals, the decoding control unit can effectively use the data of the moving picture stream not completely decoded by the video decoder.

Furthermore, the decoding unit may be configured to adjust a length of the cycle according to a content of each of the moving picture streams of channels.

Furthermore, a content of each of the moving picture streams of the first and second channels may be an image size, and when the video decoder starts decoding the moving picture stream of the first channel and within the one period of the cycle after the start of the decoding, the video decoder completes decoding the picture of the moving picture stream of the first channel, the decoding control unit may be configured to (i) supply the subsequent picture of the moving picture stream of the first channel when the image size of the moving picture stream of the first channel is larger than the image size of the moving picture stream of the second channel, and (ii) supply the moving picture data of the second channel when the image size of the moving picture stream of the second channel is larger than the image size of the moving picture stream of the first channel.

Furthermore, a content of each of the moving picture streams of the first and second channels may be a coding standard, and when the video decoder starts decoding the moving picture stream of the first channel and within the one period of the cycle after the start of the decoding, the video decoder completes decoding the picture of the moving picture stream of the first channel, the decoding control unit may be configured to (i) supply the subsequent picture of the moving picture stream of the first channel when the decoding of the moving picture stream of the first channel takes longer than decoding of the moving picture stream of the second channel, and (ii) supply the moving picture data of the second channel when the decoding of the moving picture stream of the second channel takes longer than the decoding of the moving picture stream of the first channel.

Furthermore, a content of each of the moving picture streams of the first and second channels may be a bit rate, and when the video decoder starts decoding the moving picture stream of the first channel and within the one period of the cycle after the start of the decoding, the video decoder completes decoding the picture of the moving picture stream of the first channel, the decoding control unit may be configured to (i) supply the subsequent picture of the moving picture stream of the first channel when the bit rate of the moving picture stream of the first channel is higher than the bit rate of the moving picture stream of the second channel, and (ii) supply the moving picture data of the second channel when the bit rate of the moving picture stream of the second channel is higher than the bit rate of the moving picture stream of the first channel.

Furthermore, a content of each of the moving picture streams of the first and second channels may be a field angle, and when the video decoder starts decoding the moving picture stream of the first channel and within the one period of the cycle after the start of the decoding, the video decoder completes decoding the picture of the moving picture stream of the first channel, the decoding control unit may be configured to (i) supply the subsequent picture of the moving picture stream of the first channel when the decoding of the moving picture stream of the first channel takes longer than decoding of the moving picture stream of the second channel, and (ii) supply the moving picture data of the second channel when the decoding of the moving picture stream of the second channel takes longer than the decoding of the moving picture stream of the first channel.

Furthermore, a content of the moving picture streams of the first and second channels may be a picture structure, and when the video decoder starts decoding the moving picture stream of the first channel and within the one period of the cycle after the start of the decoding, the video decoder completes decoding the picture of the moving picture stream of the first channel, the decoding control unit may be configured to (i) supply the subsequent picture of the moving picture stream of the first channel when the moving picture stream of the first channel has a field structure, and (ii) supply the moving picture data of the second channel when the moving picture stream of the second channel has a frame structure.

Furthermore, the moving picture decoding apparatus may further include an anomaly detection unit configured to detect an anomaly in the moving picture streams of channels stored in the buffer memory, wherein the decoding control unit may be configured not to supply the video decoder with a moving picture stream of a channel which is included in the moving picture streams of channels and in which an anomaly is detected by the anomaly detection unit.

Furthermore, the anomaly detection unit may be configured to detect a decrease in a carrier-to-noise ratio (C/N ratio) of each of the moving picture streams of channels.

It is to be noted that the present invention may be implemented not only as the apparatus but also as, for example, an integrated circuit which includes the process units included in the apparatus, a method which includes steps of the process units included in the apparatus, a program which causes a computer to execute these steps, and information, data, or signals which represent the program. These program, information, data, and signals may be distributed via a recording medium such as CD-ROM and a communication network such as the Internet.

### EFFECTS OF THE INVENTION

According to the present invention, it is possible to provide a moving picture decoding apparatus which has one decoder that decodes the data of multiple channels through the time-division processing and which is capable of ensuring its operation even with heavy decoding processing and is capable of making the best use of the decoder that performs the time-division decoding processing.

### BRIEF DESCRIPTION OF DRAWINGS

FIG. 1 is a block diagram showing a configuration of a conventional moving picture decoding apparatus.

FIG. 2 is a view showing how the conventional moving picture decoding apparatus performs its time-division decoding processing.

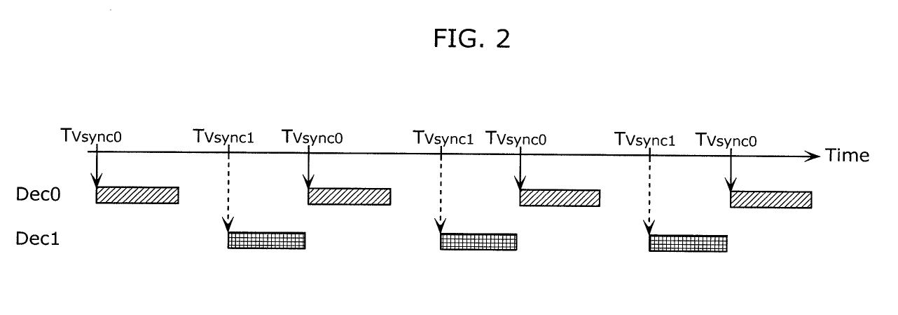

FIG. 3 is a view showing how the conventional moving picture decoding apparatus performs its time-division decoding processing.

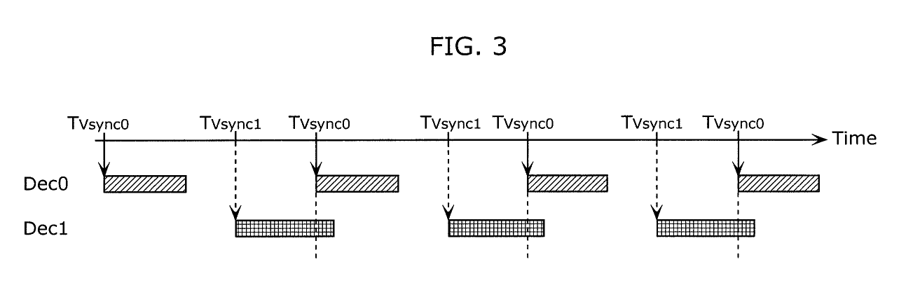

FIG. 4 is a block diagram showing a configuration of a moving picture decoding apparatus according to the first embodiment of the present invention.

FIG. 5 is a view showing how the moving picture decoding apparatus according to the first embodiment of the present invention performs its time-division decoding processing.

FIG. 6 is a view showing how the moving picture decoding apparatus according to the first embodiment of the present invention performs its time-division decoding processing.

FIG. 7 is a flowchart for explaining the operation of the time-division decoding processing of the moving picture decoding apparatus according to the first embodiment of the present invention.

FIG. 8 is a view showing how the moving picture decoding apparatus according to the first embodiment of the present invention switches the decoding processing in the time division manner.

FIG. 9 is a block diagram showing a configuration of a moving picture decoding apparatus according to the second embodiment.

### NUMERICAL REFERENCES

200, 300, 900 Moving picture decoding apparatus
201 demux/stream write control unit
202 Buffer memory
203 Header-search/read control unit
204 Video decoder
205 Save memory
206 Frame buffer
207 Display control unit
208, 308 Decoding control unit
209 Memory
210 Display device
311 Anomaly detection unit
903 Buffer memory

### BEST MODE FOR CARRYING OUT THE INVENTION

Embodiments of the present invention will be explained below with reference to the drawings. It should be noted that the following embodiments are specific examples of the present invention and not in any way intended to limit the technical scope of the present invention. In addition, the elements denoted by the same reference numerals throughout the embodiments perform the same or like operation and therefore, further explanations thereof may be omitted.

### First Embodiment

In the first embodiment, a moving picture decoding apparatus 200 will be explained in detail.

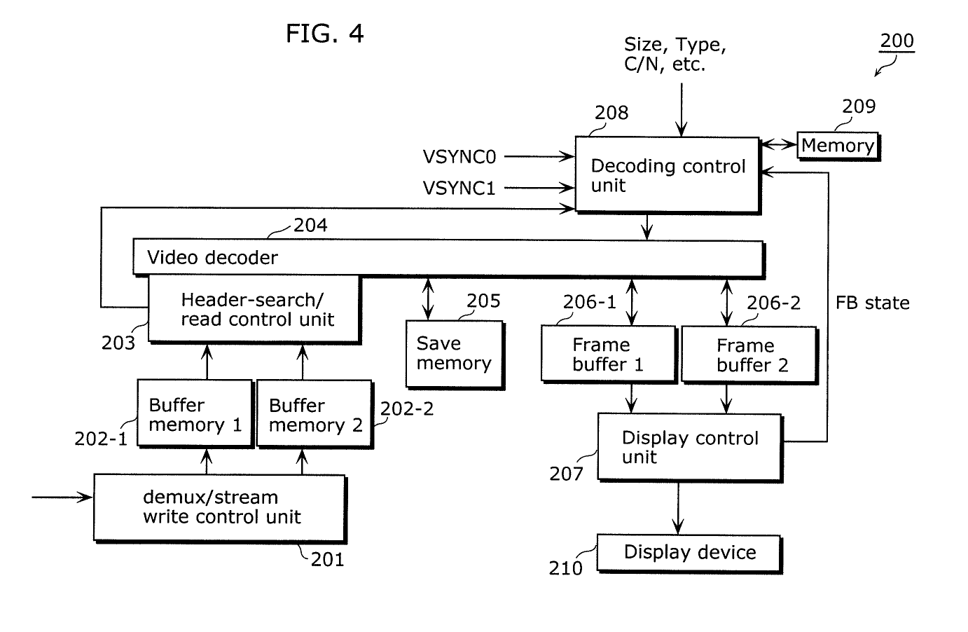

FIG. 4 is a block diagram showing a configuration of the moving picture decoding apparatus 200 according to the first embodiment.

The moving picture decoding apparatus 200 includes a demux/stream write control unit 201, a buffer memory 202, a header-search/read control unit 203, a video coder 204, a save memory 205, a frame buffer 206, a display control unit 207, a decoding control unit 208, and a memory 209.

The demux/stream write control unit 201 demultiplexes inputted streams. The inputted streams are, for example, moving picture streams of two channels (referred to as Ch0 and Ch1).

The demux/stream write control unit 201 writes each of the demultiplexed moving picture streams of Ch0 and Ch1 into its corresponding areas of the buffer memory 202.

The buffer memory 202 stores data of demultiplexed moving picture streams of multiple channels. The buffer memory 202 has physical or logical areas for respective demultiplexed data of the channels.

By way of example, the buffer memory 202 is composed of two physical buffer memories 202-1 and 202-2 in the following explanation.

The buffer memory 202-1 stores data of the demultiplexed moving picture stream of Ch0, which is one of the channels, for example. The buffer memory 202-2 stores data of the demultiplexed moving picture stream of Ch1, which is the other of the channels.

The header-search/read control unit 203 searches for header information from the data of the moving picture streams of Ch0 and Ch1 stored in the buffer memory 202 (the buffer memories 202-1 and 202-2).

According to instructions given by the decoding control unit 208 via the video decoder 204, the header-search/read control unit 203 reads out the data of the moving picture stream of Ch0 or Ch1 which is specified by the searched-for header information from a corresponding one of the buffer memory 202-1 and the buffer memory 202-2, and then inputs the read data to the video decoder 204.

The video decoder 204 decodes the data of the moving picture stream of Ch0 or Ch1 which is read by the header-search/read control unit 203.

The video decoder 204 is made of a single decoder and decodes the data of moving picture streams of channels in the time division manner. Herein, the data of the moving picture streams of Ch0 and Ch1 are decoded in the time division manner. Hereinafter, Dec0 denotes a logical decoder which decodes the data of the moving picture stream of Ch0 in the time division manner, and Dec1 denotes a logical decoder which decodes the data of the moving picture stream of Ch1 in the time division manner.

The save memory 205 is a memory which holds the data of the moving picture stream of Ch0 or Ch1 which is not completely decoded by the video decoder 204, together with information indicating that.

For example, in the case where, while the data of the moving picture stream of Ch0 is being decoded in Dec0, Dec1 starts decoding the data of the moving picture stream of another channel, i.e., Ch1 (that is, in the case where the decoder is switched from Dec0 to Dec 1), the save memory 205 temporarily stores the not completely decoded data of the moving picture stream of Ch0 and the information indicating that.

Furthermore, in the case where the decoder is switched from Dec0 to Dec1 and the save memory 205 holds the not completely decoded data of the moving picture stream to be decoded by Dec1 and the information indicating that, which the save memory 205 stored upon the last switching, Dec1 resumes the decoding processing from the not completely decoded data which is read from the save memory 205

The frame buffer 206 stores data of the moving picture stream decoded in the time division manner by the video decoder 204.

The frame buffer 206 has physical or logical areas for the respective data of moving picture streams of channels decoded in the time division manner by the video decoder 204.

By way of example, the frame buffer 206 is composed of two physical frame buffers 206-1 and 206-2 in the following explanation. The frame buffer 206-1 stores data of the moving picture stream of Ch0 decoded in Dec0. The frame buffer 206-2 stores data of the moving picture stream of Ch1 decoded in Dec1.

The display control unit 207 reads out the data of the moving picture streams stored in the frame buffer 206 (the frame buffer 206-1 or the frame buffer 206-2), and outputs moving picture signals to the display device 210. This consumes a one-frame amount of memory of the frame buffer 206 (the frame buffer 206-1 or the frame buffer 206-2).

Furthermore, the display control unit 207 monitors the state of the frame buffer 206 (the frame buffer 206-1 and the frame buffer 206-2), including the remaining amount of the memory and the percentage of the amount of memory in use, and transmits the state to the decoding control unit 208.

The display device 210 receives the moving picture signals from the display control unit 207 and displays moving pictures.

For example, the display device 210 may receive the moving picture signals of Ch0 and the moving picture signals of Ch1 simultaneously from the display control unit 207, and in such a case, the screen of the display device 210 is split into two to display the moving picture of Ch0 and the moving picture of Ch1, that is, the display device 210 performs “split screen display” in which the moving pictures of two channels are shown on one screen.

It is to be noted that the display control unit 207 and the display device 210 may not be separate elements, and the display unit 207 may include the display device 210. Moreover, the display control unit 207 may be display device driver software or include display device driver software and the like to provide functions of the display device 210.

The decoding control unit 208 controls a channel having data to be decoded by the video decoder 204, and a timing of execution of the decoding processing.

The decoding control unit 208 determines the channel having data to be decoded and the timing of execution of the decoding processing based on the following three rules and thereby causes the video decoder 204 to execute the time-division decoding processing. The following three rules are set in the decoding control unit 208 in advance. Rule 1 is fundamental, and Rule 2 and Rule 3 are supplemental to the Rule 1.

1) Upon the lapse of a predetermined time while the video decoder 204 is decoding the moving picture stream of Ch0 or Ch1, the data of moving picture stream being decoded by the video decoder 204 is switched.

2) The switching of the data of the moving picture stream being decoded by the video decoder 204 is triggered by the state of the frame buffer 206.

3) The data of the moving picture streams which the video decoder 204 decodes is switched according to contents of the moving picture streams.

According to the Rule 1, the decoding control unit 208 switches the data of the moving picture streams which the video decoder 204 decodes, between Ch0 and Ch1 at predetermined time intervals denoted by 1V, for example. In other words, the decoding control unit 208 switches the logical decoder of the video decoder 204 between Dec0 and Dec1 at predetermined time intervals 1V.

Herein, it is assumed that the time required for the display device 210 to display one frame on a screen is 2V. For example, according to the National Television Standards Committee (NTSC) format, there are approximately 30 frames per second, and 1V corresponds to approximately 1/60 second.

The predetermined time depends on the number of channels which the display device 210 can display on one screen, and is given by the following expression. In The first embodiment, the predetermined time 1V is calculated as: 2V/2CH=1V.

(Predetermined time)=2V (time required for one frame)/the number of channels

The Rule 1 secures the minimum time (1V) for the decoding processing, that is required for the display device 210 to display moving pictures. Furthermore, according to this Rule 1, the space of the frame buffer 206 can be prevented from being exhausted (running out) with the data stored therein after the decoding processing, which is necessary for the normal play.

In the case where the logical decoder is switched, the decoding process on data of a channel is interrupted and the data being decoded is stored in the save memory 205 if its restoration is possible, and upon next switching of the decoding processing back to the channel, the decoding process resumes from where interrupted.

The decoding control unit 208 switches the moving picture streams which the video decoder 204 decodes, between Ch0 and Ch1 in accordance with, for example, the state (e.g., the total or remaining amount of the memory) of the frame buffer 206-1 or the frame buffer 206-2, under the Rule 2.

When the frame buffer 206-1 runs out of free space (in the case of FM Full), it is not necessary to perform the decoding processing any more and therefore, the decoding control unit 208 promptly switches the moving picture streams which the video decoder 204 decodes, from Ch0 to Ch1 even before a lapse of the predetermined time 1V under the Rule 1. In other words, the decoding control unit 208 monitors the state of the frame buffer 206-1 or the frame buffer 206-2 and assigns to another logical decoder an idle time that is generated when the decoding processing cannot be performed.

The Rule 2 eliminates the need to decode the data of the moving picture stream which is not storable in the frame buffer 206 after decoded by the video decoder 204, allowing for an effective use of the time or the like which would otherwise be wasted by such decoding.

Furthermore, under the Rule 3, the decoding control unit 208 switches the moving picture streams which the video decoder 204 decodes, between Ch0 and Ch1 according to, for example, contents of the moving picture streams which are stored in the buffer memory 202-1 or the buffer memory 202-2. The contents of the moving picture streams include an image size, a coding standard, a bit rate, a field angle, and a video structure (a picture structure), for example.

In addition, under the Rule 3, the decoding control unit 208 causes the video decoder 204 to perform the decoding processing on data of the channel Ch0 and Ch1 with the corresponding timings so that a longer time can be used to decode the moving picture stream which takes longer to be decoded.

The image size indicates a size of an image represented by the number of pixels (each of which is the minimum unit of an image). For example, the image size is given a value such as 2560×1920, 1280×960, or 640×480, that is, “the number of pixels in width multiplied by the number of pixels in height”. The image size of 640×480 may be referred to as standard definition (SD) and the image size of 2560×1920 may be referred to as high definition (HD). In the case where the content of the moving picture stream is an image size, a load exerted on the video decoder 204 during the decoding processing varies depending on the image size and therefore, under the Rule 3, the decoding control unit 208 switches the moving picture stream being decoded, between Ch0 and Ch1 according to the load. To be specific, the decoding control unit 208 switches the moving picture streams between Ch0 and Ch1 so that the length of time for the video decoder 204 to decode the data including a large image size can be as long as possible.

The coding standard includes MPEG2, MPEG4, H.264, JPEG, WMV9, and DivX, indicating a compression method for moving picture data. In the case where the content of the moving picture stream is a coding standard, just as in the case described above, a load exerted on the video decoder 204 during the decoding processing varies depending on the standard and therefore, under the Rule 3, the decoding control unit 208 switches the moving picture stream being decoded, between Ch0 and Ch1 according to the load. That means that the moving picture stream is switched between Ch0 and Ch1 so that a longer time can be used to decode the moving picture stream of the coding standard which takes long to be decoded.

The bit rate indicates, as a rate, a data amount of moving picture signals inputted for one second, which corresponds to a data mount (the number of bits) of the moving picture data to be converted per second. Generally, the higher the bit rate is, the higher the image quality and the sound quality are, but with an increase in the file size. The lower the bit rate is, the smaller the file size is, but with decreases in the image quality and in the sound quality. A higher bit rate results in a heavier load on the video decoder 204 in the decoding processing. In the case where the content of the moving picture stream is a bit rate, just as in the case described above, the decoding control unit 208 switches the moving picture stream between Ch0 and Ch1 so that the video decoder 204 can perform for a long time the decoding processing on the moving picture stream of which bit rate is high.

The field angle indicates an amount of information which can be displayed in video, including information related to resolution such as high definition (HD) and standard definition (SD). Higher resolution results in a heavier load on the video decoder 204 in the decoding processing. Accordingly, in the case where the content of the moving picture stream is a field angle, the decoding control unit 208 switches the moving picture streams between Dec0 and Dec1 so that the video decoder 204 can perform for a long time the decoding processing on the moving picture stream of high resolution.

The picture structure is, specifically, information related to a field, a frame, and the like. If a certain moving picture stream has a field structure, two images in a top filed and in a bottom filed need to be decoded to completely decode one image (frame). For the normal play, there is no problem as long as at least one frame is decoded during the period of 2V, and therefore the moving picture stream is switched between Dec0 and Dec1 when decoding two images is completed in the case with a field structure or when decoding one image is completed in the case with a frame structure.

It is to be noted that the above-described save memory 205, in which the data of the moving picture stream not completely decoded is saved, does not have to be provided. In such a case, it is not until the decoding of the moving picture stream in a predetermined unit of decoding processing is completed that the moving picture stream is switched between Dec0 and Dec1. Alternatively, the data of the moving picture stream not completely decoded may be discarded and that data of the moving picture stream may be decoded again. In such a case, the decoding process resumes from the beginning of the data in the unit of the decoding processing. If the processing speed is prioritized, the data of the moving picture stream not completely decoded may be discarded so that the processing can continue.

As another method for spending, under the Rule 3, a longer time to the decoding of the moving picture stream which takes long to be decoded, the length of the predetermined time (1V) under the Rule 1 may be adjusted.

The content of the moving picture stream provided to the decoding control unit 208 may be given from outside or alternatively be determined based on the header information which is analyzed by the header-search/read control unit 203.

The frame buffer 206 may have a memory threshold set, over which it is determined that the memory is used up, that is, there is no free space in the memory. In this case, the threshold is preferably 100% in view of the effective use of resources, but not limited to this value. Needless to say, it may also be possible to set a threshold of remaining memory of the frame buffer 206, below which it is determined that the memory is used up, that is, there is no free space in the memory.

As described above, the Rule 1 ensures the minimum length of time for the decoding processing, and the Rule 2 and the Rule 3 coordinate the Rule 1 to make an effective use of the extra time.

As compared to the case where only the Rule 1 is implemented, the implementation of the Rule 2 and Rule 3 allows for a longer decoding time so that performance in the special playback mode, at a start of the decoding processing, or at the like time can be sufficiently brought out. An example to show this will be described with reference to the drawings

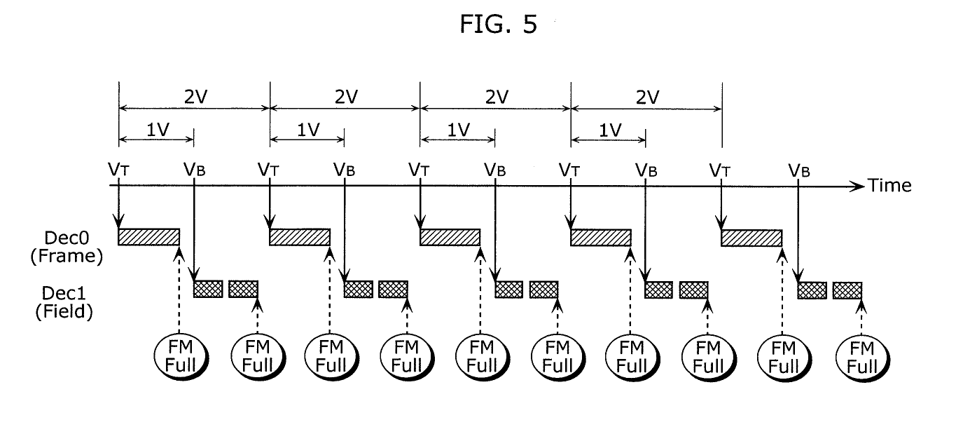

FIG. 5 is a view showing how the moving picture decoding apparatus performs its time-division decoding processing.

The moving picture stream including two channels of Ch0 and Ch1 is decoded in the time division manner by a single decoding unit; i.e., the video decoder 204. Here, the moving picture stream of Ch0 is decoded in Dec0, and the moving picture stream of Ch1 is decoded in Dec1.

Switching between Dec0 and Dec1 corresponds to switching of the moving picture stream which is decoded by the video decoder 204 in the time division manner between Ch0 and Ch1. The data of the moving picture stream of Ch0 stored in the buffer memory 202-1 or the data of the moving picture stream of Ch1 stored in the buffer memory 202-2 is read from the header-search/read control unit 203 to the video decoder 204 when instructed by the decoding control unit 208

FIG. 5 shows a case where the data of Ch0 is reproduced in Dec0 in the normal play mode, and the data of Ch1 is reproduced Dec 1 in the normal play mode, for example. Here, the data of the moving picture stream decoded by Dec0 and Dec1 are stored in the frame buffer 206-1 and in the frame buffer 206-2, respectively. The moving picture stream of Ch0 has a frame picture structure, and the moving picture stream of Ch1 has a field picture structure.

In a steady state of the normal play, the data supply rate to the frame buffer 206-1 and the frame buffer 206-2 through the decoding processing of the video decoder 204 is higher than the data consumption rate in the frame buffer 206-1 and in the frame buffer 206-2 through the image output by the display control unit 207. Accordingly, in this case, the memory of the frame buffer 206-1 and the frame buffer 206-2 are basically full (FM Full), and only when the memory is consumed by the display control unit 207, the video decoder 204 performs the decoding processing. The timing to consume memory of the frame buffer 206-1 is indicated by V_{T}, and the timing to consume memory of the frame buffer 206-2 is indicated by V_{B}. In the model illustrated herein, each of V_{T} and V_{B} comes about at the intervals of 1V.

The decoding processing starts at V_{T} or V_{B} and when the decoding processing for one frame is completed, the frame buffer 206-1 or the frame buffer 206-2 goes into the FM Full state again, which should cause switching of the channel to be decoded. However, because all the channels are in the FM Full states, data of none of the channels can be decoded, with the result that the decoding processing is suspended until the memory of the frame buffer 206-1 or the frame buffer 206-2 is consumed.

Afterwards, in the like manner, the decoding control unit 208 causes switching between Dec0 and Dec1 under the Rule 2.

As just described, in the normal play, decoding the data of the moving picture stream under the Rule 2 makes it possible to provide the moving picture decoding apparatus 200 which is capable of performing the time-division decoding processing.

In FIG. 5, there is a blank in each decoding processing in Dec1 which continues for the same channel. This is because a header of the moving picture stream to be decoded needs to be read by the header-search/read control unit 203 before the moving picture stream is decoded by the video decoder 204. The blank shows a small amount of time which is required when the decoding processing for the same channel continues.

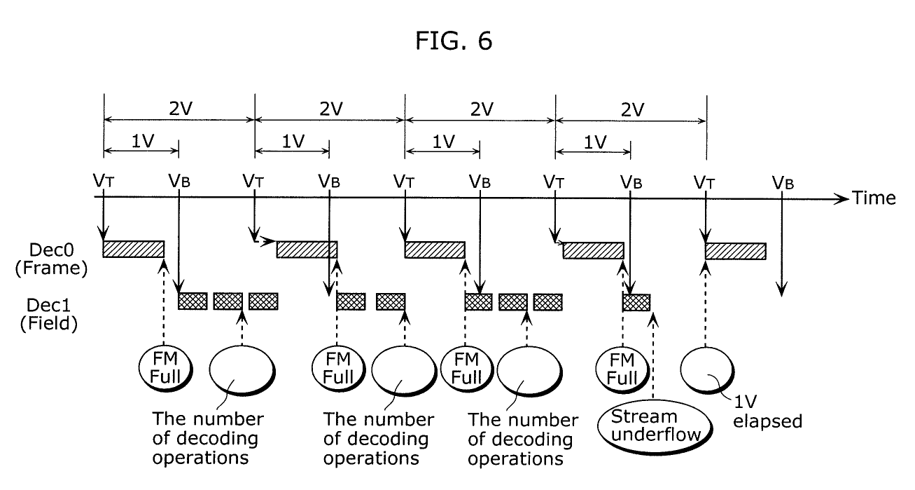

FIG. 6 is a view showing how the moving picture decoding apparatus performs its time-division decoding processing.

FIG. 6 shows a case where the data of Ch0 is reproduced in the normal play mode, and the data of Ch1 is reproduced in the special playback mode. The special playback includes high-speed play at 1.6 times speed and reverse play, for example. In the special playback mode, images are outputted from the display control unit 207 to the display device 210 at a designated reproduction speed according to a special playback instruction given by a user. FIG. 6 shows a case where the save memory 205 is not provided or not used. The other conditions are the same as those in FIG. 5.

Dec0 which performs the normal play is normally in the FM Full state, and the video decoder 204 therefore performs the decoding processing only when the memory of the frame buffer 206-1 is consumed through the image output at V_{T}. Dec1 which is operating in the special playback mode does not go into the FM Full state because the memory consumption by the display control unit 207 is faster than the data supply to the frame buffer 206-2 through the decoding processing of the video decoder 204.

First, the decoding processing in Dec0 starts at V_{T}, the memory of the frame buffer 206-1 becomes Full (FM Full), and the decoder is thus switched from Dec0 to Dec1 under the Rule 2. After that, the picture data of the moving picture stream of Ch1 is decoded in Dec1.

The moving picture stream of Ch1 has a field structure. Accordingly, the picture data of the moving picture stream of Ch1 is decoded in Dec1 for the number of decoding operations to make one frame (two times in this example) under the Rule 3.

In this case, since Ch1 is reproduced in Dec1 in the special playback mode as instructed by a user, the memory of the frame buffer 206-2 does not become Full (FM Full) when decoding of the two picture data of the moving picture stream of Ch1 is completed in Dec 1. In other words, since the images are outputted from the display control unit 207 to the display device 210 with an earlier (accelerated) timing than in the normal play mode, the memory of the frame buffer 206-2 does not become Full (FM Full).

Now, it is assumed that the time 1V has not elapsed when the time for the number of decoding operations to make one frame (two times in this example) passes; specifically, when the decoding of the picture data of the moving picture stream of Ch1 is completed.

Next, the decoding control unit 208 switches the decoder from Dec1 to Dec0 under the Rule 3 when the time for the number of decoding operations to make one frame (two times in this example) passes; specifically, when the decoding of the picture data of the moving picture stream of Ch1 is completed.

However, since it is before next V_{T}, in other words, since no images have been outputted from the display control unit 207 to the display device 210, the memory of the frame buffer 206-1 has not been consumed (still in the FM Full state). The decoding control unit 208 therefore switches the decoder promptly from Dec0 to Dec1 under the Rule 2.

Next, the decoding control unit 208 attempts to switch the decoder from Dec1 to Dec0 under the Rule 1 when the time 1V has elapsed (at V_{T}).

However, the decoding processing in Dec1 cannot stop because of absence of the save memory 205, with the result that a stand-by state is set until Dec1 completes the decoding processing for one picture (one field).

When Dec1 completes the decoding processing for one picture (one filed), the decoder is switched from Dec1 to Dec0 under the Rule 1.

Next, the decoding control unit 208 likewise attempts to switch the decoder from Dec0 to Dec1 under the Rule 1 when the time 1V has elapsed (the second V_{B} in the figure).

However, the decoding processing in Dec0 cannot stop because of absence of the save memory 205, with the result that a stand-by state is set until Dec0 completes the decoding processing for one picture (one field).

When Dec0 completes the decoding processing for one picture (one frame), the decoder is switched from Dec0 to Dec1 under the Rule 1.

Afterwards, in the like manner, the decoding control unit 208 causes switching between Dec0 and Dec1 under the Rule 1 in combination with the supplemental Rule 2 and Rule 3.

In addition, there is a case where, during the special playback, the video decoder 204 cannot perform its decoding processing because the stream data to be decoded is not available in time due to a decreased rate of the data supply from the demux/stream write control unit 201 to the buffer memory 202 (which case is indicated as Stream underflow in the figure). In this case, the channels are not switched under the Rule 2 and the Rule 3, but are switched under the Rule 1 after a lapse of 1V, with the result that the decoding processing in Dec1 is not suspended.

As just described, also in the case of the special playback, decoding the data of the moving picture stream under the three rules makes it possible to maximize the length of time for the substantial decoding processing of the video decoder 204. Thus, even in the case where Dec1 operates in the special playback mode, it is possible to secure the minimum length of time (1V) for the decoding processing in Dec0. This allows for the moving picture decoding apparatus 200 which is capable of performing the time-division decoding processing with the least possible idle time by making the best use of the video decoder 204.

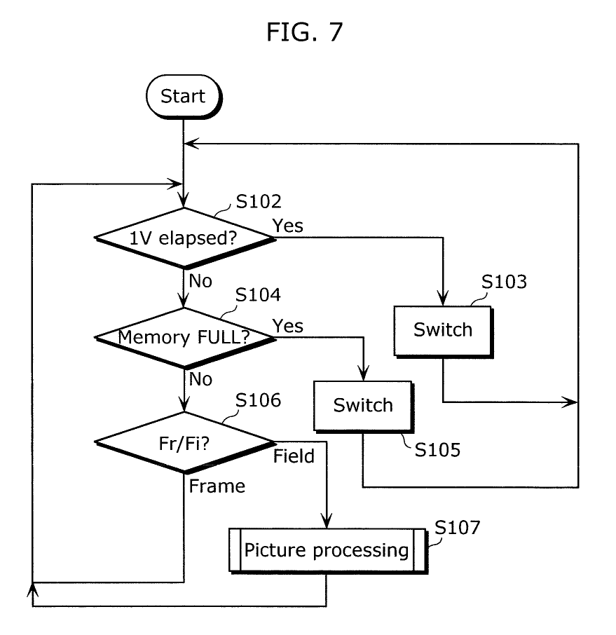

FIG. 7 is a flowchart for explaining the operation of the time-division decoding processing of the moving picture decoding apparatus 200.

In the moving picture decoding apparatus 200, the decoding control unit 208 counts the time that the video decoder 204 (Dec0 and Dec1) decodes the data of the moving picture streams of Ch0 and Ch1.

Furthermore, the decoding control unit 208 monitors the states (e.g., memory amount) of the buffer memory 202-1 and the buffer memory 202-2 via the display control unit 207.

Furthermore, the decoding control unit 208 monitors via the header search/read control unit 203 the contents of the moving picture streams of Ch0 and Ch1 stored in the buffer memory 202-1 and the buffer memory 202-2.

First, upon a lapse of the time 1V (the predetermined time) in the decoding processing in Dec0 (when Yes in S102), the decoding control unit 208 switches the data of the moving picture stream which the video decoder 204 decodes from one data (of Ch0) to another (of Ch1). That is, the decoding control unit 208 switches the logical decoders of the video decoder 204 from Dec0 to Dec1 within the time 1V (within the predetermined time) under the Rule 1.

Next, the lapse of the time 1V (the predetermined time) has not elapsed in the decoding processing in Dec0 (when No in S102), the decoding control unit 208 checks the memory of the frame buffer 206-1 and the frame buffer 206-2.

For example, when the state of the frame buffer 206-1 in which the data of the moving picture stream of Ch0 decoded by Dec0 is stored is 100%, that is, Full (when Yes in S104), the decoding control unit 208 switches the data of the moving picture streams which the video decoder 204 decodes from one data (of Ch0) to another (of Ch1). That is, the decoding control unit 208 switches the logical decoders of the video decoder 204 from Dec0 to Dec1 under the Rule 2.

When the state of the frame buffer 206-1 in which the data of the moving picture stream of Ch0 decoded by Dec0 is stored is not Full (when No in S104), the decoding control unit 208 checks the picture structure of the moving picture stream (Ch0) read from the buffer memory 202-1 to the video decoder 204; that is, the picture structure of the data of the moving picture stream being decoded in Dec0 (S106).

Next, for example, when the picture structure of the data of the moving picture stream being decoded in Dec0 is a field structure (when Field in S106), the decoding control unit 208 causes Dec0 to continue its decoding processing within the time 1V (within the predetermined time) until the minimum unit that the display device 210 can display, i.e., one frame, is made (S107).

That is, the decoding control unit 208 switches the logical decoders of the video decoder 204 from Dec0 to Dec1 within the time 1V (within the predetermined time) under the Rule 3.

Thus, the decoding processing including picture processing continues for a required length of time by following the loop of steps S102 to S107 until the time 1V defined by the Rule 1 elapses (within the predetermined time).

The picture processing indicated in FIG. 7 is decoding processing continuing for a required length of time in view of the picture structure of the moving picture stream.

For example, when the picture structure of the data of the moving picture stream being decoded in Dec0 is a frame structure (when Frame in S106), the decoding processing continues by returning to Start and following the loop of steps S102 to S107 until the time 1V defined by the Rule 1 elapses (within the predetermined time).

As described above, the moving picture decoding apparatus 200 decodes the data of the moving picture stream in the time division manner under the three rules.

It is to be noted that the content of the moving picture stream is not limited to a picture structure which is cited as an example in the above description. The content of the moving picture stream may be an image size, a coding standard, a bit rate, a codec type, or a field angle, for example.

(Variation)

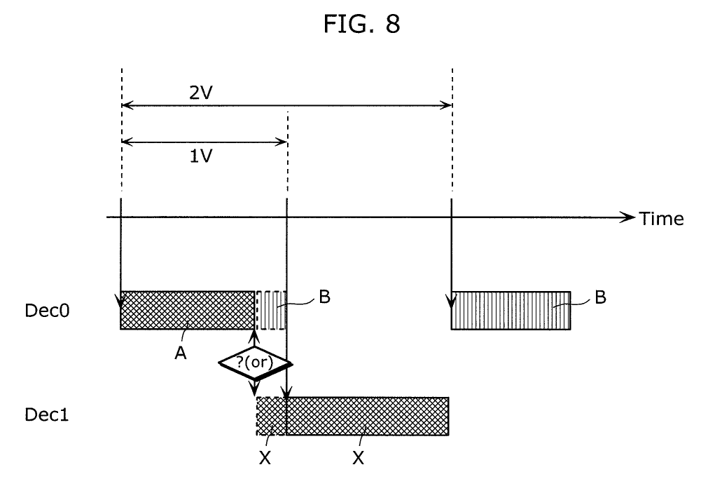

FIG. 8 is a view showing how the moving picture decoding apparatus switches decoding processing in the time division manner.

As shown in FIG. 8, the decoding processing on picture data A of the moving picture stream of Ch0 is completed in Dec0 within the first 1V. In this case, next decoding processing may be either accelerated decoding processing of Dec0 on picture data B of the moving picture stream or decoding processing of Dec1 on picture data X of the moving picture stream of Ch1.

In the above explanation for the first embodiment, when the data of Ch0 is reproduced in Dec0 in the normal play mode, the memory of the frame buffer 206-1 is Full (used up). In the present variation, even when the data of Ch0 is reproduced in Dec0 in the normal play mode, the memory of the frame buffer 206-1 may not be Full. In such a case, the decoding processing is performed earlier so that the time-division decoding processing can be performed with the least possible idle time. That is, if there is an extra processing time within the time 1V that is the predetermined time, next decoding processing can be performed earlier to make the best use of the video decoder 204.

This allows for the moving picture decoding apparatus which has one decoder that decodes the data of multiple channels through the time-division processing under the three rules according to the first embodiment of the present invention and which is capable of performing time-division decoding processing with the least possible idle time by making the best use of the decoder.

### Second Embodiment

In the second embodiment, a moving picture decoding apparatus 300 will be explained in detail.

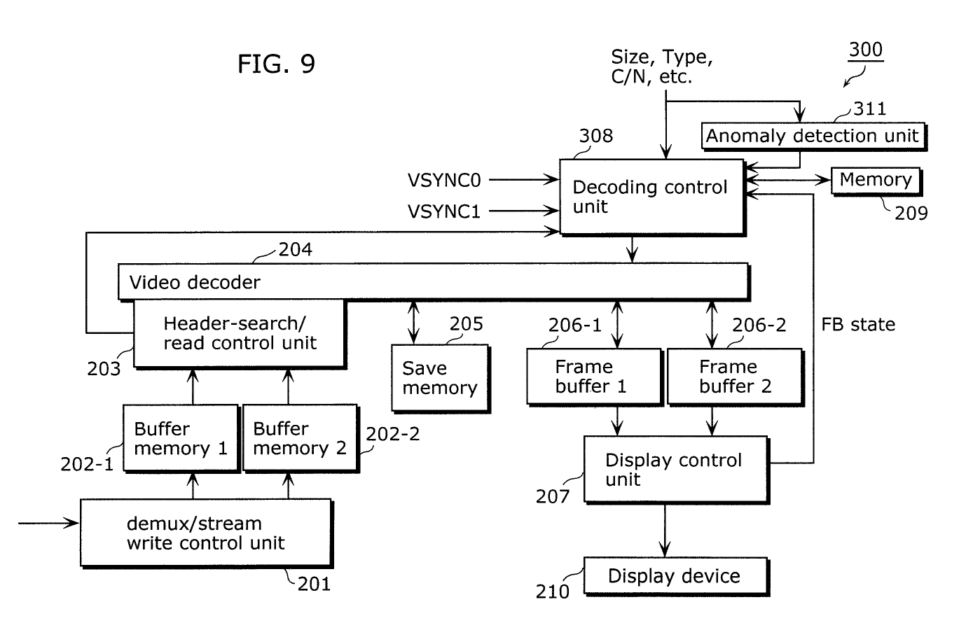

FIG. 9 is a block diagram showing a configuration of the moving picture decoding apparatus 300 according to the second embodiment.

The moving picture decoding apparatus 300 includes the demux/stream write control unit 201, the buffer memory 202, the header-search/read control unit 203, the video coder 204, the save memory 205, the frame buffer 206, the display control unit 207, a decoding control unit 308, the memory 209, and an anomaly detection unit 311.

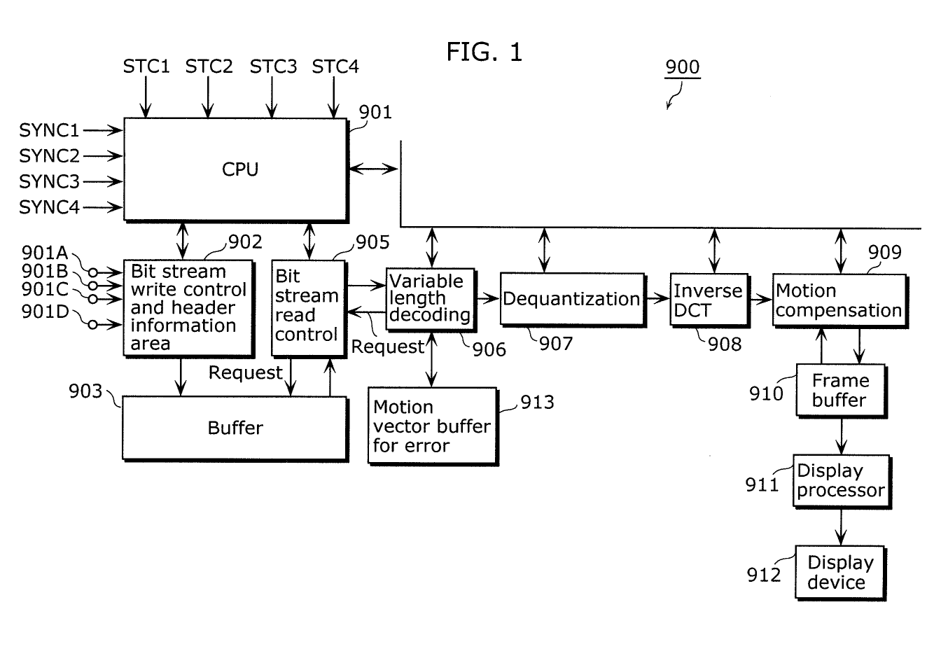

Components similar to the components shown in FIG. 1 are assigned the same numerical identifiers so that their detailed description will be omitted.

The moving picture decoding apparatus 300 shown in FIG. 9 is different from the moving picture decoding apparatus 200 according to the first embodiment in that the anomaly detection unit 311 is provided.

The anomaly detection unit 311 detects whether or not there is any anomaly in the moving picture streams (Ch0 and Ch1) which the video decoder 204 decodes. The anomaly referred to herein includes, for example, a decrease in a carrier-to-noise ratio (C/N ratio).

The C/N ratio is a ratio of a carrier wave to a noise, and a higher value in the ratio indicates a better state.

The anomaly detection unit 311 monitors the data of the moving picture streams (Ch0 and Ch1) which are stored in the buffer memory 202 (202-1 and 202-2). The anomaly detection unit 311 monitors, for example, whether the C/N ratio decreases.

When the anomaly detection unit 311 detects a decrease of the C/N ratio in the data of the respective moving picture streams (Ch0 and Ch1) which are stored in the buffer memory 202 (202-1 and 202-2), the anomaly detection unit 311 notifies the decoding control unit 308 that an anomaly is found in the moving picture stream which the video decoder 204 decodes, including information that the anomaly is found in the data of which moving picture stream.

When the anomaly detection unit 311 detects an anomaly in the data of the moving picture stream (Ch0) which is stored in the buffer memory 202-1, for example, the decoding control unit 308 performs processing to suppress the decoding processing on the data of the moving picture stream (Ch0). To be specific, the decoding control unit 308 does not switch the logical decoder of the video decoder 204 which performs the decoding processing, from Dec1 to Dec0, but regressively switches from Dec1 to Dec1. This means that the decoding control unit 308 causes the video decoder 204 to continue the decoding processing in Dec1 in the case where the anomaly detection unit 311 detects an anomaly in the data of the moving picture stream (Ch0) which is stored in the buffer memory 202-1.

If the processing continues to decode the data of the moving picture stream having an anomaly, it often results in decoded images with extremely poor quality. Thus, such decoding processing itself may go to waste.

For this reason, the data of the moving picture stream (e.g., Ch0) in which an anomaly is detected is not decoded so that a decoding resource (a decoding time) which would otherwise be consumed is used for decoding another moving picture stream (e.g., Ch1) in which no anomaly is detected, allowing for an effective use of the decoding resource. Furthermore, avoiding unnecessary decoding processing can also reduce power consumption.

The other elements of the decoding control unit 308 are similar to those of the decoding control unit 208 and therefore will not be described again.

In addition, although the anomaly detection unit 311 and the decoding control unit 308 are explained as separate blocks in the second embodiment, the monitoring for anomalies conducted by the anomaly detection unit 311 may be conducted by the decoding control unit 308.

As above, in the second embodiment of the present invention, the moving picture decoding apparatus 300 is capable of making the best use of resources for decoding in a decoding circuit by performing not only the time-division decoding processing under the three rules but also adding the control based on the presence or absence of an anomaly in the moving picture stream. This allows for the moving picture decoding apparatus 300 which has one decoder that decodes the data of multiple channels through the time-division processing and which is capable of making the best use of the decoder and thereby performing the time-division decoding processing with the least possible idle time.

It is to be noted that although, by way of example, two channels are described in the above explanation as the multiple channels of which data is to be decoded in the time division manner by the video decoder 204, the number of channels is not limited thereto and may be three, six, or any other figures without limitation. Furthermore, the buffer memory 202 and the frame buffer 206 include two buffer memories and two frame buffers, respectively, in the above explanation, but the present invention is not limited thereto. The number of these components in either logical or physical form is not limited. In addition, as a picture structure of the moving picture streams of two channels, the examples with the frame structure/frame structure and the frame structure/field structure are explained above, but the present invention is not limited to these examples, and the field structure and the frame structure may be freely combined.

So far, the moving picture decoding apparatus according to the present invention has been explained based on the embodiments, but the present invention is not limited to these embodiments. The scope of the present invention includes various variation of the embodiments which will occur to those skilled in the art, and other embodiments in which element of different embodiments are combined, without departing from the basic principles of the present invention.

### INDUSTRIAL APPLICABILITY

The present invention can be applied to a moving picture decoding apparatus and in particular to a set device which decodes a moving picture, such as a DVD recorder using a next-generation DVD standard and a security camera required to show multiple displays on one screen.

1. A moving picture decoding apparatus comprising:
a buffer memory in which moving picture streams of channels are stored;
a video decoder which decodes the moving picture streams of channels read out from said buffer memory;
a frame buffer which stores moving picture data of the moving picture streams of channels decoded by said video decoder;
a display control unit configured to read out the moving picture data from said frame buffer and output a moving picture signal corresponding to the moving picture data; and
a decoding control unit configured to cause said video decoder to decode the moving picture streams in a time division manner by switching the moving picture streams of channels which said decoding control unit supplies from said buffer memory to said video decoder
wherein said decoding control unit is configured to supply the respective moving picture streams of channels to said video decoder in a cycle, and
when said video decoder starts decoding the moving picture stream of a first channel and within one period of the cycle after the start of the decoding, said video decoder completes decoding a picture of the moving picture stream of the first channel, said decoding control unit is configured to supply said video decoder with a subsequent picture of the moving picture stream of the first channel, the subsequent picture being decoded by said video decoder.

2. (canceled)

3. The moving picture decoding apparatus according to claim 1,
wherein said frame buffer has areas for the respective moving picture streams of channels, and
when the area for the moving picture stream of the first channel lacks sufficient free space, said decoding control unit is configured to supply said video decoder with the moving picture stream of a second channel even before a lapse of the one period of the cycle.

4. The moving picture decoding apparatus according to claim 3,
wherein when said video decoder starts decoding the moving picture stream of the first channel and within the one period of the cycle after the start of the decoding, said video decoder completes decoding the picture of the moving picture stream of the first channel, said decoding control unit is configured to determine, according to a content of the moving picture stream of the first channel, whether to supply the subsequent picture of the moving picture stream of the first channel or to supply the moving picture data of the second channel.

5. The moving picture decoding apparatus according to claim 1,
wherein when said video decoder starts decoding the moving picture stream of the first channel and within the one period of the cycle after the start of the decoding, said video decoder completes decoding the picture of the moving picture stream of the first channel, said decoding control unit is configured to determine, according to a content of the moving picture stream of the first channel, whether to supply the subsequent picture of the moving picture stream of the first channel or to supply the moving picture data of the second channel.

6. The moving picture decoding apparatus according to claim 1, further comprising
a save memory which holds data of one of the moving picture streams of channels not completely decoded by said video decoder,
wherein when said video decoder is decoding the moving picture stream of a first channel upon switching of the moving picture streams of channels which said video decoder decodes, from the moving picture stream of the first channel to the moving picture stream of a second channel, said decoding control unit is configured to instruct said save memory to hold data of the moving picture stream of the first channel not completely decoded by said video decoder.

7. The moving picture decoding apparatus according to claim 6,
wherein when said save memory holds the data of the moving picture stream of the second channel not completely decoded by said video decoder upon switching of the moving picture streams of channels which said video decoder decodes, from the moving picture stream of the first channel to the moving picture stream of the second channel, said decoding control unit is configured to instruct said save memory to read out the data of the moving picture stream of the second channel to said video decoder.

8. The moving picture decoding apparatus according to claim 1,
wherein said decoding unit is configured to adjust a length of the cycle according to a content of each of the moving picture streams of channels.

9. The moving picture decoding apparatus according to claim 4,
wherein a content of each of the moving picture streams of the first and second channels is an image size, and
when said video decoder starts decoding the moving picture stream of the first channel and within the one period of the cycle after the start of the decoding, said video decoder completes decoding the picture of the moving picture stream of the first channel, said decoding control unit is configured to (i) supply the subsequent picture of the moving picture stream of the first channel when the image size of the moving picture stream of the first channel is larger than the image size of the moving picture stream of the second channel, and (ii) supply the moving picture data of the second channel when the image size of the moving picture stream of the second channel is larger than the image size of the moving picture stream of the first channel.

10. The moving picture decoding apparatus according to claim 4,
wherein a content of each of the moving picture streams of the first and second channels are a coding standard, and
when said video decoder starts decoding the moving picture stream of the first channel and within the one period of the cycle after the start of the decoding, said video decoder completes decoding the picture of the moving picture stream of the first channel, said decoding control unit is configured to (i) supply the subsequent picture of the moving picture stream of the first channel when the decoding of the moving picture stream of the first channel takes longer than decoding of the moving picture stream of the second channel, and (ii) supply the moving picture data of the second channel when the decoding of the moving picture stream of the second channel takes longer than the decoding of the moving picture stream of the first channel.

11. The moving picture decoding apparatus according to claim 4,
wherein a content of each of the moving picture streams of the first and second channels is a bit rate, and
when said video decoder starts decoding the moving picture stream of the first channel and within the one period of the cycle after the start of the decoding, said video decoder completes decoding the picture of the moving picture stream of the first channel, said decoding control unit is configured to (i) supply the subsequent picture of the moving picture stream of the first channel when the bit rate of the moving picture stream of the first channel is higher than the bit rate of the moving picture stream of the second channel, and (ii) supply the moving picture data of the second channel when the bit rate of the moving picture stream of the second channel is higher than the bit rate of the moving picture stream of the first channel.

12. The moving picture decoding apparatus according to claim 4,
wherein a content of each of the moving picture streams of the first and second channels is a field angle, and
when said video decoder starts decoding the moving picture stream of the first channel and within the one period of the cycle after the start of the decoding, said video decoder completes decoding the picture of the moving picture stream of the first channel, said decoding control unit is configured to (i) supply the subsequent picture of the moving picture stream of the first channel when the decoding of the moving picture stream of the first channel takes longer than decoding of the moving picture stream of the second channel, and (ii) supply the moving picture data of the second channel when the decoding of the moving picture stream of the second channel takes longer than the decoding of the moving picture stream of the first channel.

13. The moving picture decoding apparatus according to claim 4,
wherein a content of the moving picture streams of the first and second channels is a picture structure, and
when said video decoder starts decoding the moving picture stream of the first channel and within the one period of the cycle after the start of the decoding, said video decoder completes decoding the picture of the moving picture stream of the first channel, said decoding control unit is configured to (i) supply the subsequent picture of the moving picture stream of the first channel when the moving picture stream of the first channel has a field structure, and (ii) supply the moving picture data of the second channel when the moving picture stream of the second channel has a frame structure.

14. The moving picture decoding apparatus according to claim 1, further comprising
an anomaly detection unit configured to detect an anomaly in the moving picture streams of channels stored in said buffer memory,
wherein said decoding control unit is configured not to supply said video decoder with a moving picture stream of a channel which is included in the moving picture streams of channels and in which an anomaly is detected by said anomaly detection unit.

15. The moving picture decoding apparatus according to claim 14,
wherein said anomaly detection unit is configured to detect a decrease in a carrier-to-noise ratio (C/N ratio) of each of the moving picture streams of channels.
